(19) United States
(12) Patent Application Publication
(10) Pub. No.: US 2014/0304084 A1
(43) Pub. Date: Oct. 9, 2014

(54) DYNAMIC PRODUCT BUNDLING

(71) Applicant: Tightrope Interactive, Inc., San Francisco, CA (US)

(72) Inventors: John Nguyen, San Francisco, CA (US); Franco Yuvienco, San Francisco, CA (US)

(21) Appl. No.: 13/935,266

(22) Filed: Jul. 3, 2013

Related U.S. Application Data
(60) Provisional application No. 61/853,577, filed on Apr. 5, 2013.

(51) Int. Cl. G06Q 30/02

(52) U.S. Cl. CPC G06Q 30/0269
USPC 705/14.66

(57) ABSTRACT

Systems for generating dynamic primary product bundles. The dynamic primary product bundles can be generated to include a requested primary product and a second primary product. The primary products can be represented as static elements in a product array. The product bundle can include conditions that must be met in order for the second primary product to be displayed on a requestors device. At runtime the bundle can be dynamic in that the second primary product can not be displayed unless the conditions are met.

### REFERENCE TO EARLIER-FILED APPLICATION

This application claims priority to U.S. Provisional Patent Application Ser. No. 61/853,577, filed Apr. 5, 2013, entitled “Dynamic Product Bundling.”

### BACKGROUND

An area of ongoing research and development is the bundling of products together. Bundling of products is particularly important to software. Specifically, many types of software programs are designed to function with other types of software programs. Furthermore, as software can be easily purchased and used by being downloaded from a network, offering a number of software programs together through a bundled product can increase revenue as a user might be more inclined to download or purchase related software that is presented to them after downloading a specific software program.

As a result, software product bundles have been created that include software products and advertised software products. Entities have been developed to create software product bundles and offer the software product bundles for other software producers or publishers. The advertised software products can be offered through either free access or free trial access. There are however limitations of current software product bundling services. Specifically, once the software bundle is created what software products are included in the software bundle cannot be changed. This is especially problematic in software were new software products and new versions of existing software products are constantly created. As a result, bundling services need to create software product bundles for every new software product or new version of an existing software product. There therefore exists a need for a systems and methods for creating software bundles that can be dynamically changed after the software bundle has been created. There also exists a need for a software bundle to dynamically change what software products are displayed to the user during runtime.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems for generating dynamic primary products. The dynamic primary product bundles can be generated to include a requested primary product and a second primary product. The primary products can be represented as static elements in a product array. The product bundle can include conditions that must be met in order for the second primary product to be displayed on a requestors device. At runtime the bundle can be dynamic in that the second primary product can not be displayed unless the conditions are met.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system configured to create a dynamic product bundle.

FIG. 2 depicts a diagram of an example of another system configured to create a dynamic product bundle.

FIG. 3 depicts a diagram of an example of another system configured to create a dynamic product bundle.

FIG. 4 depicts a diagram of an example of a system configured to create a dynamic product bundle and monitor the downloading of the products within the bundle.

FIG. 5 depicts a diagram of an example of another system configured to create a dynamic product bundle and monitor the downloading of the products within the bundle.

FIG. 6 depicts a diagram of an example of another system configured to create a dynamic product bundle and monitor the downloading of the products within the bundle.

FIG. 7 depicts a flowchart of an example of a method for creating a dynamic product bundle.

FIG. 8 depicts a flowchart of an example of a method for creating and operating a dynamic product bundle.

FIG. 9 depicts a flowchart of an another example of a method for creating and operating a dynamic product bundle that is dynamic at runtime.

FIG. 10 depicts a flowchart of an example of a method for creating a product bundle, installing products in a product bundle and monitoring user activities.

### DETAILED DESCRIPTION

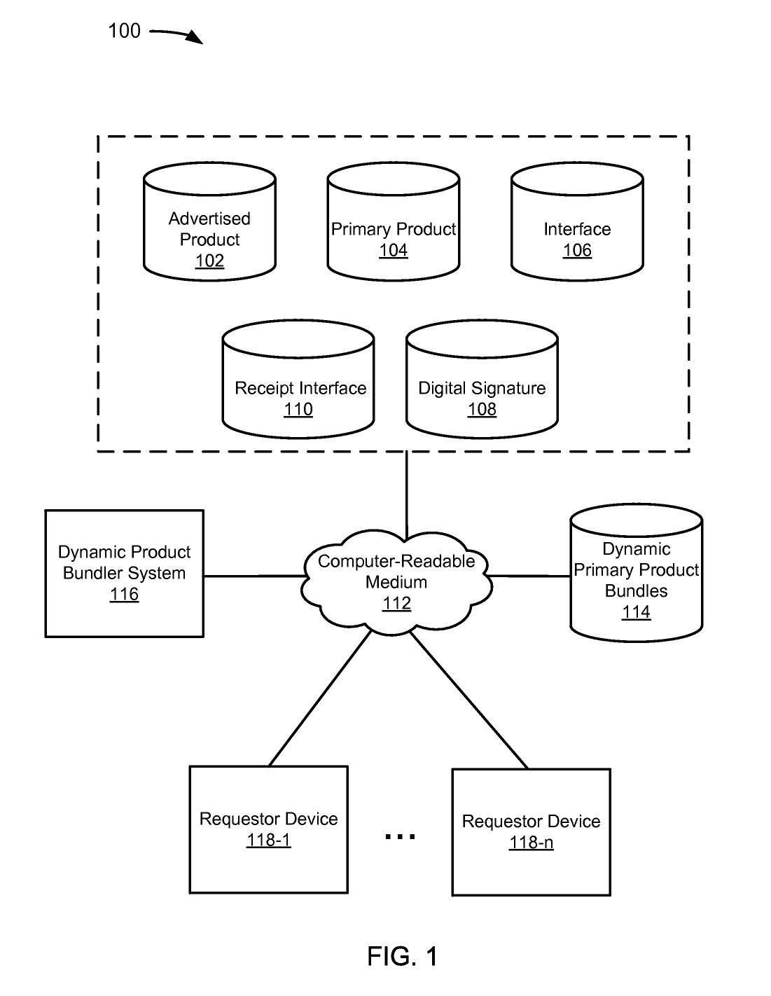

FIG. 1 depicts a diagram 100 of an example of a system configured to create a dynamic product bundle. In the example of FIG. 1, the diagram 100 includes an advertised product datastore 102, a primary product datastore 104, an interface datastore 106, a digital signature datastore 108 and a receipt interface datastore 110.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

The primary product datastore 104 can contain data about primary products. A primary product can be any number of application programs that includes any number of executable files and any number of associated files. For example, the primary product can be Photoshop®. The executable files can be executed by a computer system. The primary product can also be only a data file associated with or parsed by a specific application program. For example, the primary product can be a “.pdf” data file. The executable files and associated files of the primary product can be downloadable. The primary product can be an application program or data file that is popular to users. The popularity of the application program or data file can be based on the number of users that have requested to download the product. The popularity of the application program or data file can also be based on the number of users that are expected to download the product. The primary product can be a free product, e.g. an open source product, or a paid-for product that requires payment before the user can use the product. The primary product can be a trial version of a paid-for product, in which the user can interact with or use the product for a certain amount of time without paying.

The data about primary products can include product uniform resource locators (hereinafter URL). The product URL can provide a reference to a location in a network or the Internet from which the primary product can be downloaded. The product URL can be static in that it provides a reference to a location for the same primary product. Additionally, as the product URL is static, if a new version of the product is created, the new version can be assigned to a different static product URL. Therefore, a user can download any version of a product by accessing the specific product URL of the desired version of the product.

The data about primary products can also include characteristics data of a primary product. The characteristic data can include the producer of the primary product, the provider of the primary product, or a function of the primary product. The characteristics data can also include the attributes of the primary product. The characteristics data can be used to tag a primary product or a group of primary products for easy locating and retrieval of the URL of the primary product from the primary product datastore 104. For example, if the primary product is a video editing program, the characteristics data of the primary product can include media editor. Based on the media editor characteristics data, the example primary product can be grouped together with all of the primary products that are tagged as media editors. Additionally, the characteristics data can be used to store all or some of the URLs of primary products that have shared characteristics in specific locations within the primary product datastore 104 to further aid in location and retrieval of the URLs of primary products from the primary product datastore 104.

The data about primary products can also include primary product system requirements data. The primary product system requirements data can be information indicating the hardware components or software resources that are necessary to run a specific primary product on a device. For example, if a primary product can only be executed using a certain operating system, the primary product system requirements data can include an indicator that the certain operating system must be present on the device in order to run the primary product. The primary product system requirements data can also be the computational resources that are necessary to execute the primary product on the device. For example, the primary product system requirements data can include the amount of available random-access memory (RAM) in the device that is required to run the primary product on the device.

The data about primary products can also include associated primary product data. The associated primary product data can include the identification of primary products that are associated with a specific primary product and the location of the URL of the associated primary products in the primary product datastore 104. Primary products can be associated if they are produced or provided by the same entity. Primary products can also be associated based on the number of users that requested both the primary product and the associated primary products. For example, if a large number of users request a media editor program and a media broadcasting program, the media editor program and the media broadcasting program can be characterized as associated primary products. Primary products can also be associated if they are different versions of the same product. For example if a primary product is one version of a product and another primary product is a different version of the same product, then the primary products can be associated primary products. Primary products can also be associated if they have common characteristics. For example, all of the products that are characterized as being media editors can be associated.

The data about primary products can also include associated advertised products data. The associated advertised products data can include identification information and characteristic information of advertised products that are associated with a primary product. Data about the associated advertised products can be stored on the advertised product datastore 102. The associated advertised products data can also include the location information of the advertised products data, that is stored on the advertised product datastore 102, of an advertised product that is associated with a specific primary product. An advertised product can be associated with a primary product if they are produced or provided by the same entity. An advertised product can also be associated with a primary product based on the number of users that download both the primary product and the associated advertised product. Primary products can also be associated to advertised products if they are different versions of the same product. For example if a primary product is one version of a product and an advertised product is a different version of the same product, then the primary product and the advertised product can be an associated primary product and advertised product.

The advertised product datastore 102 can contain data about advertised products. An advertised product can be any number of application programs that includes any number of executable files and any number of associated files. The executable files can be executed by a computer system. The advertised product can also be only a data file associated with or parsed by a specific application program. The executable files and associated files of the advertised product can be downloadable. The advertised product can be an application program or data file that a user has not requested as a primary product. In an example implementation, a product can serve as an advertised product for one user if the user has not requested it as a primary product, and serve as a primary product for another user if the user has requested it as a primary product. The advertised product can be a free product, e.g. an open source product, or a paid-for product that requires payment before the user can use the product. The advertised product can be a trial version of a paid-for product, in which the user can interact with or use the product for a certain amount of time without paying.

The data about advertised products can include a product URL. The product URL can provide a reference to a location in a network or the Internet from which the advertised product can be downloaded. The product URL can be static in that it constantly provides a reference to a location for the same advertised product. Additionally, as the product URL is static, if a new version of the advertised product is created, the new version can be assigned to a different static product URL. Therefore, a user can download any version of an advertised product by accessing the specific product URL of the desired version of the advertised product.

The data about advertised products can also include the characteristics data of an advertised product. The characteristics data can include the producer of the advertised product, the provider of the advertised product, or a function of the advertised product. The characteristics data can also include attributes of the advertised product. The characteristics data can be used to tag an advertised product or a group of advertised products for easy locating and retrieval of the URL of the advertised product from the advertise product datastore 102. For example, if the advertised product is a video editing program, the characteristics data of the advertised product can include media editor. Based on the media editor characteristics data, the example advertised product can be grouped together with all of the advertised products that are tagged as media editors. Additionally, the characteristics data can be used to store all or some of the URLs of the advertised products that have shared characteristics in specific locations within the advertised product datastore 102 to further aid in location and retrieval of advertised product URLs from the advertised product datastore 102.

The data about advertised products can also include advertised product system requirements data. The advertised product system requirements data can be information indicating the hardware components or software resources that are necessary to run a specific advertised product on a device. For example, if an advertised product can only be executed using a certain operating system, the advertised product system requirements data can include an indicator that the certain operating system must be present on the device in order to run the advertised product. The advertised product system requirements data can also be the amount of computational resources that are necessary to execute the advertised product on the device. For example, the advertised product system requirements data can include the amount of available random-access memory (RAM) in the device that is required to run the advertised product on the device.

The data about advertised products can also include associated advertised product data. The associated advertised product data can include the identification of advertised products of advertised products associated with an advertised product and the location of the URL of associated advertised products in the associated product datastore 102. Advertised products can be associated if they are produced or provided by the same entity. Advertised products can also be associated based on the number of users that download both the advertised product and the associated products. For example, if a large number of users download a media editor program as an advertised product and a media broadcasting program as an advertised product, the media editor program and the media broadcasting program can be characterized as associated advertised products. Advertised products can also be associated if they have common characteristics. For example, all or any number of the advertised products that are characterized as being media editors can be associated.

The data about advertised products can also include associated primary products data. The associated primary products data can include identification information of primary products that are associated with an advertised product. Associated primary product and advertised product data can be stored on the primary product datastore 104. Associated primary product and advertised product data can also include the location information of the primary products data, that is stored on the primary product datastore 104, of a primary product that is associated with a specific advertised product. A primary product can be associated with an advertised product if they are produced or provided by the same entity. An primary product can also be associated with an advertised product based on the number of users that download both the advertised product and the associated primary product. Advertised products can also be associated to primary products if they are different versions of the same product. For example if an advertised product is one version of a product and a primary product is a different version of the same product, then the advertised product and the primary product can be an associated advertised product and primary product. Primary products can also be associated with an advertised product if they have common characteristics. For example, if both a primary product and an associated product are characterized as being media editors, then they can be associated.

The interface datastore 106 can contain data about interfaces. The interfaces can be presented to a requestor before or during the downloading of a specific product. In being presented to a requestor before or during the downloading of a specific product each interface can be linked with a specific product. Specifically, the interface can be the graphical interface that is shown to a user that prompts the user as to whether or not they want to download the product. The interface can be a skin.

The data about interfaces can include an interface template. The interface template can be used to create a customized interface. The customized interface can be included as part of the interface data contained in the interface datastore 106. The interface template can include appearance variables. The appearance variables can allow the publisher or producer of the product to define certain appearance or functional aspects of a customized interface. For example, if a published or producer indicates a desire for an interface to be a certain color, a user can manipulate an appearance variable to create a customized interface that is a certain color. The interface template can also include a message variable. The message variable can allow a producer or publisher to insert a desired message into a customized interface. The desired message can be related to the product for which the customized interface is displayed before or during downloading of the product.

The data about interfaces can also include interface association data. The interface association data can include information that can tie a certain publisher, producer or product with an interface or customized interface. For example, if a producer has selected a certain color to create a customized interface, then the interface association data can tie the customized interface to all products that are created by the producer. In another example, if a producer selected a certain color to create a customized interface for a certain product, then the interface association information can tie the customized interface to the specific product so that the customized interface is displayed to users who request or download all versions of the specific product.

The digital signature datastore 108 can contain data about digital signatures. The data about digital signature can include what digital signatures are associated with what products and vice versa. The digital signatures can be the digital signatures of publishers or producers of the primary and advertised products. Specifically, the digital signatures can be the signature of people associated with a specific publisher or producer who have the authority to approve the creation of a bundle of products that includes at least one product of the specific publisher or producer.

The data about digital signatures can include the actual digital signature. The data about digital signatures can also include the password used with each digital signature. The data about digital signatures can include digital certificate association data. The digital certificate association data can include the producers, publishers or products that are associated with each digital certificate. Specific producers can be associated with a digital certificate if the person whom the digital signature represents has the authority to approve the creation of a bundle that includes at least one of the specific products. Specific publishers and producers can be associated with a digital certificate if the person whom the digital signature represents has the authority to approve the creation of a bundle that includes at least one product that is created by or published by one of the specific producers or publishers.

The receipt interface datastore 110 can contain data about receipt interfaces. A receipt interface can be an interface that is presented to a requestor after the requestor has downloaded a primary product or an advertised product. In being presented to a requestor after the requestor has downloaded a specific product each receipt interface can be linked with a specific product, producer or publisher. A receipt interface can include a textual or graphical message to the requestor. The message can be a generic thank you message. A receipt interface can also include a link to another product. The link can direct a requestor to the product URL of the other product. The receipt interface can also include a message to the requestor that includes a description of the other product. The description of the other product and the product URL of the other product can be retrieved from the data about primary products and advertised products that is contained on the advertised product datastore 102 and the primary product datastore 104.

The data about receipt interfaces can include a receipt interface URL. Each specific receipt interface can have a specific receipt interface URL. The specific receipt interface URL can provide a reference to a location in a network or the Internet from where the specific receipt interface can be accessed. Each specific receipt interface URL can be static in that it constantly provides a reference to a location for the same receipt interface. The data about receipt interfaces can also include receipt interface association data. The receipt interface association data can include which products, producers or publishers that the receipt interface is associated with.

The data about receipt interfaces can include a receipt interface template. The receipt interface template can include a product variable. The product variable can allow a producer or publisher to insert a URL or multiple URLs to other products in a customized receipt interface. The products can be products that are described or represented by the data about primary products stored on the primary product datastore 104 and the data about advertised products stored on the advertised product datastore 102. The receipt interface template can also include one or a plurality of appearance variables. The appearance variables can include any number of characteristics related to the appearance of a receipt interface. The appearance variables can allow a producer or a publisher of a product to configure the appearance of a customized receipt interface. For example, if the producer or publisher wants the receipt interface of a certain product to be a certain color, the producer or published can create a customized interface for the product that is the desired color using the appearance variables. The receipt interface template can also include a message variable. The message variable can allow a producer or publisher to insert a desired message into a customized receipt interface. The desired message can be related to the product URLs that are inserted through the product variable. The desired message can also be related to the product for which the receipt interface is displayed after downloading.

In the example of FIG. 1, the advertised product datastore 102, the primary product datastore 104, the interface datastore 106, the digital signature datastore 108 and the receipt interface datastore 110 are coupled to a computer-readable medium 112.

The computer-readable medium, as used in this paper, is intended to represent a variety of potentially applicable technologies. Specifically, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. Additionally, a computer-readable medium can be used to form a network or part of a network. The network can be a wired or a wireless network. Where two components are co-located on a device, a computer-readable medium can include a bus or other data conduit or plane. Where a first component is co-located on one device and a second component is located on a different device, a computer-readable medium can include a wireless or wired back-end network or LAN. A computer-readable medium can also encompass a relevant portion of a WAN or other network, if applicable.

In the example of FIG. 1, a dynamic product bundler system 116, a dynamic primary product bundles datastore 114 and requestor devices 118-1 . . . 118-n are coupled to the computer-readable medium 112. The dynamic product bundler system 116, the dynamic primary product bundles datastore 114 and requestor devices 118-1 . . . 118-n are coupled to the advertised product datastore 102, the primary product datastore 104, the interface datastore 106, the digital signature datastore 108 and the receipt interface datastore 110 through the computer-readable medium 112.

The computer-readable medium 112, the dynamic product bundler system 116 and the other systems and computer-readable mediums described in this paper can be implemented through computer systems, engines or a plurality of any combination of computer systems and engines. An engine, as used in this paper, includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor.

The computer systems described in this paper can be implemented through or be part of an engine. A computer system, as used in this paper, is intended to be construed broadly. In general, a computer system will include a processor, memory, non-volatile storage and an interface. A typical computer system will usually include at least a processor, memory and a device (e.g., a bus) coupling the memory to the processor. The processor can be, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash. and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The requestor devices 118-1 . . . 118-n are devices through which a user can request a primary product and receive bundles of products that can include both primary and advertised products. The requestor devices 118-1 . . . 118-n can be computer systems. The requestor devices 118-1 . . . 118-n can be a client wireless device such as a laptop computer.

The dynamic product bundler system 116 can function to create a dynamic product bundle. The product bundle can be dynamic in that the products that are presented to the user as part of the bundle change at runtime. Runtime, as is used in this paper, can be defined to be the time after which at least a portion of the product bundle is transferred to the request device and during which the user interacts with the product bundle. The dynamic product bundler system 116 can create the dynamic primary product bundle to include a product array. The product array can include elements. The elements can be static in that they do not change after being created. In creating a dynamic product bundle, the dynamic product bundler system 116 can receive a request from a user to download a primary product. The dynamic product bundler system 116 can also receive identification information of the network browser software on the requestor device 118-1 . . . 118-n through which a user requested to download a primary product.

The dynamic product bundler system 116 can retrieve data about the requested primary product from the primary product datastore 104. The dynamic product bundler system 116 can use the retrieved data about the requested primary product to create an element in the product array that represents the primary product. Specifically, the element in the product array that represents the primary product can be the product URL of the requested primary product. Through the URL a user can be directed or linked to a location from where the primary product can be downloaded.

The dynamic product bundler system 116 can also use the retrieved data about the requested primary product to retrieve data about other primary products that are associated with the requested primary product. For example, if the requested primary product is a media editor program, the dynamic product bundler system 116 can retrieve data about other primary products that are characterized as media editors and are, therefore, associated primary products. In another example if a user requests an older version of a product, the dynamic product bundler system can retrieve data about the primary products that are newer versions of the product, and are, therefore, associated primary products. The dynamic product bundler system 116 can create elements in the product array that represent the associated primary products. The elements can be static in that they do not change after the product bundle is created and during runtime. Therefore multiple primary products can be represented in the product array of the product bundle. Which primary products are displayed to the user for download through the bundle, as will be discussed later, can be dynamically controlled at runtime.

The dynamic product bundler system 116 can also use the retrieved data about the requested primary product to retrieve data about advertised products that are associated with the requested primary product or primary products associated with the requested primary product. The data about advertised products associated with primary products can be retrieved from both the advertised products datastore 102 and the primary products datastore 104. The dynamic bundler system 116 can then create elements in the product array that represent the associated advertised products. The elements can be static in that they do not change after being created. The dynamic product bundler system 116 can also retrieve data about other advertised products that are associated with the advertised products associated with the primary products. The dynamic product bundler system 116 can use this retrieved data to create elements in the product array that represent that additional association advertised products. The elements can be static in that they do not change at runtime.

The dynamic product bundler system 116 can also use the retrieved data about the primary products and the advertised products to create conditions. The conditions can be requirements that must be met before an interface through which a user can download a certain product included in the bundle, either advertised or primary, is displayed on the requestor device 118-1 . . . 118-n. The conditions can be based on any of the data that is contained in the advertised product datastore 102, the primary product datastore 104, the interface datastore 106, the receipt interface datastore 110 or the digital signature datastore 108. For example, the conditions can be based on the system requirements that are necessary to run the product. In another example, the conditions can also be based on other characteristics of the product such as the version of the product.

In one implementation of the product bundle, the products are displayed to the user in a sequential order based on the location at which the products are created in the array. The dynamic product bundler system 116 can create the array so that the primary products are displayed on the requestor device 118-1 . . . 1180-n first in the sequential order. The dynamic product bundler system 116 can create the sequential order based upon the conditions that are created for each product. For example if a user requests an older version of a product, the newer version of the product can be created at a position in the array so that it is displayed before the older version of the product in the sequential order. In another example, if one product in the product bundle must be downloaded onto the requestor's device in order to run or execute another product in the product bundle, then the product that must be downloaded to run the other product can be positioned in the array so that is displayed before the other product on the requestor device.

The dynamic product bundler system 116 can also retrieve digital signatures from the digital signature datastore 108. The digital signatures can also be used to create the array. Specifically, the digital signatures can be used to authenticate the products that are bundled into the product bundle or approve of the inclusion of the products into the specific product bundle.

The dynamic product bundler system 116 can also retrieve interface data from the interface datastore. The interfaces can be the graphical interfaces that are displayed to a user before the user downloads a product and during the downloading of a product if the user chooses to download the product. The interface data can include customized interfaces that are created by a producer or published of the product. The interface data can also include interface association data that can be used by the dynamic product bundler system 116 to display a certain interface or customized interface when a specific product that the interface is tied to is displayed on the requestor device 118-1 . . . 118-n.

The dynamic product bundler system 116 can retrieve data about receipt interfaces from the receipt interface datastore 110. The dynamic product bundler system 116 can use the receipt interface association data received from the receipt interface datastore 110 to determine which product to display the receipt interface with after the product has been downloaded.

The dynamic product bundle that is created by the dynamic product bundler system 116 can be stored on the dynamic primary product bundles datastore 114. The dynamic product bundle can also be sent to any of the requestor devices 118-1 from either the dynamic primary product bundles datastore 114 or the dynamic product bundler system 116.

During runtime, the product bundle is dynamic in that the pointer that is used to interact with the product bundle as part of running the product bundle on the requestor device 118-1 . . . 118-n is adjustable. The pointer is adjustable in that it points to an element, representing a primary product, in the product array based upon the conditions. Specifically, in running the product bundle on the requestor device 118-1 . . . 118-n the requestor device characteristics are determined. Such characteristics can be the operating system that the device utilizes, what other products are installed or are available on the requestor device or the computational resources that are available on the requestor device 118-1 . . . 118-n. The requestor device characteristics can be used to determine whether or not the conditions are met. Based upon whether or not the conditions are met the pointer can alternate between different elements contained in the array. As the pointer alternates, different products, including primary products, represented by different elements, can be displayed during runtime out of the sequential order that corresponds to the placement of the elements within the product array. As to whether or not conditions are met can depend on the requestor device, a user on one requestor device who is running the dynamic product bundle may see different products from another user on another request device who is running the same dynamic product bundle. Therefore, the dynamic product bundle can display different products, including primary products, dynamically at runtime.

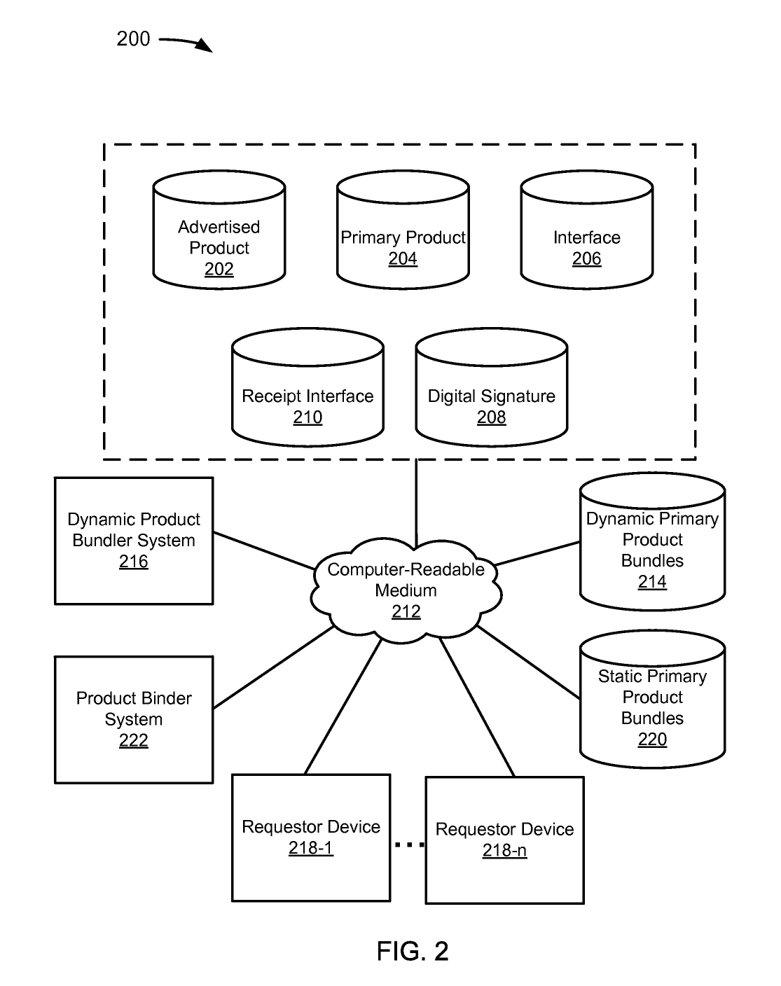

FIG. 2 depicts a diagram 200 of an example of another system configured to create a dynamic product bundle. The system shown in FIG. 2 can include an advertised product datastore 202, a primary product datastore 204, an interface datastore 206, a digital signature datastore 208 and a receipt interface datastore 210.

The primary product datastore 204 can contain data about primary products. The data about primary products can include any of the data or information that is contained within the primary product datastore 104 of the example system in FIG. 1. The advertised product datastore 202 can contain data about advertised products. The data about advertised products can include any of the data or information that is contained within the advertised product datastore 102 of the example system in FIG. 1. The interface datastore 206 can contain data about interfaces. The data about interfaces can include any of the data or information that is contained within the interface datastore 106 of the example system in FIG. 1. The digital signature datastore 208 can contain data about digital signatures. The data about digital signatures can include any of the data or information that is contained within the digital signature datastore 108 of the example system in FIG. 1. The receipt interface datastore 210 can contain data about receipt interfaces. The data about receipt interfaces can include any of the data or information that is contained within the receipt interface datastore 110 of the example system in FIG. 1.

The advertised product datastore 202, the primary product datastore 204, the interface datastore 206, the digital signature datastore 208 and the receipt interface datastore 210 are coupled to computer-readable medium 212. A dynamic product bundler system 216, a dynamic primary product bundles datastore 214, a static primary product bundles datastore 220, a product binder system 222 and requestor devices 218-1 . . . 218-n are also coupled to the computer-readable medium 212.

The dynamic product bundler system 216 can function to create a dynamic product bundle. The dynamic product bundler system 216 can implement any of the methods of creating a dynamic product bundle as discussed in conjunction with the description of the dynamic product bundler system 116 of the example system in FIG. 1. The dynamic product bundle created by the dynamic product bundler system 216 can include an empty variable. A product URL that references a primary product can be injected into the empty variable of the dynamic product bundle. The dynamic product bundle is dynamic in that a product URL that references a primary product can be injected into the empty variable after the dynamic product bundle is created and before runtime. Therefore, the dynamic product bundle changes from not including a primary product after the dynamic product bundle is created to including a primary product before runtime.

The dynamic product bundle created by the dynamic product bundler system 216 can also include advertised products. The advertised products can be represented through elements in a product array. The elements can be static in that they do not change after the product bundle is created and during runtime. The product array can be part of the dynamic product bundle. The dynamic product bundler system 216 can create the product array to include the empty variable and the elements that represent the advertised product. The empty variable and the elements that represent the advertised products can be sequentially ordered within the array so that the primary product that is referenced by a static URL that is injected into the empty variable after the dynamic product bundle is created, is displayed first when the dynamic product bundle is transferred to and run on the requestor device 218-1 . . . 218-n.

The dynamic product bundler system 216 can create the dynamic product bundle so that it is associated with a primary product, that has a URL that will be injected into the empty variable after the dynamic product bundle is created. Specifically, the dynamic product bundler system 216 can create a dynamic product bundle that is associated with a characteristic of a primary product, a producer of a primary product or a publisher of a primary product. The dynamic product bundler can include data that describes the characteristic of a primary product, the producer of a primary product or the publisher of the primary product that is associated with the dynamic primary product. The advertised products included in the dynamic product bundle can be associated with a primary product that is associated with the dynamic product bundle, even though the dynamic product bundle does not include the specific primary product that the dynamic product bundle will include at runtime. Specifically, the dynamic product bundler system 216 can receive a characteristic of a primary product that will be included in the dynamic product bundle after runtime, such as a media editing product characteristic. The dynamic product bundler system 216 can then retrieve data describing advertised products associated with the media editing product characteristic from the advertised product datastore 202. The dynamic product bundler system 216 can then create the dynamic product bundle to include the advertised products associated with the media editing product characteristics along with an empty variable in which a product URL of a media editing primary product will be injected into after the dynamic product bundle is created.

The dynamic product bundle that contains the empty variable can be stored on the dynamic primary product bundles datastore 214. The product binder system 222 can receive the dynamic product bundle that contains the empty variable from either the dynamic product bundler system 216 or the dynamic primary product bundles datastore 214. The product binder system 222 can function to inject the product URL of a primary product into the empty variable after the dynamic product bundle is created and before runtime. By injecting the product URL of a primary product into the empty variable the product binder system 222 can create an element in the product array that represent a primary product. The product binder system 222 can use the data that describes the characteristic of a primary product, the producer of a primary product or the publisher of the primary product that is associated with the dynamic primary product to retrieve data about a primary product from the primary product datastore 204. The product binder system 222 can also use a request for a primary product received from a requestor device to retrieve data about a primary product from the primary product datastore 204. The data about a primary product retrieved from the primary product datastore 204 can include the product URL of the primary product that can be injected into the empty variable of the product array of the dynamic primary product bundle. By injecting into the empty variable the product URL of the primary product, the product binder system 222 can create a product bundle that is static at runtime. The product bundle is static in that the product URLs that are included within the product bundle do not change during runtime. Furthermore, the product bundle is static at runtime in that all of the primary products within the product bundle are shown to the user in the sequential order that they primary products are located in the product array. Therefore, the products that are included in the product bundle do not change at runtime according to which requestor device the product bundle is being run or which use is interacting with the product bundle.

The product bundle that includes the product array with a product URL injected into it by the product binder system 222 can be stored on the static primary product bundles datastore 220. The requestor devices 218-1 can receive the product bundle from either the product binder system 222 or the static primary product bundles datastore 220.

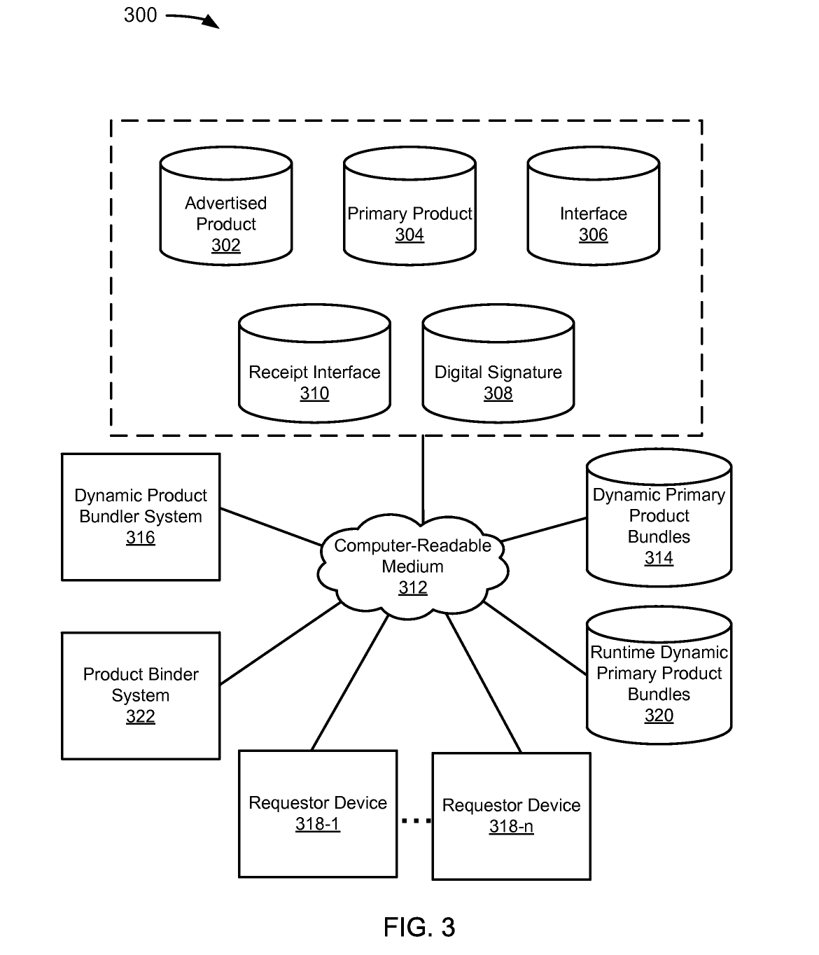

FIG. 3 depicts a diagram 300 of an example of another system configured to create a dynamic product bundle. The system shown in FIG. 3 can include an advertised product datastore 302, a primary product datastore 304, an interface datastore 306, a digital signature datastore 308 and a receipt interface datastore 310.

The primary product datastore 304 can contain data about primary products. The data about primary products can include any of the data or information that is contained within the primary product datastore 104 of the example system in FIG. 1. The advertised product datastore 302 can contain data about advertised products. The data about advertised products can include any of the data or information that is contained within the advertised product datastore 102 of the example system in FIG. 1. The interface datastore 306 can contain data about interfaces. The data about interfaces can include any of the data or information that is contained within the interface datastore 106 of the example system in FIG. 1. The digital signature datastore 308 can contain data about digital signatures. The data about digital signatures can include any of the data or information that is contained within the digital signature datastore 108 of the example system in FIG. 1. The receipt interface datastore 310 can contain data about receipt interfaces. The data about receipt interfaces can include any of the data or information that is contained within the receipt interface datastore 110 of the example system in FIG. 1.

The advertised product datastore 302, the primary product datastore 304, the interface datastore 306, the digital signature datastore 308 and the receipt interface datastore 310 are coupled to computer-readable medium 312. A dynamic product bundler system 316, a dynamic primary product bundles datastore 314, a runtime dynamic primary product bundles datastore 320, a product binder system 322 and requestor devices 318-1 . . . 318-n are also coupled to the computer-readable medium 312.

The dynamic product bundler system 316 can function to create a dynamic product bundle. The dynamic product bundler system 316 can implement any of the methods of creating a dynamic product bundle as discussed in conjunction with the descriptions of the dynamic product bundler system 116 of the example system in FIG. 1 and the dynamic product bundler system 216 of the example system in FIG. 2. The dynamic product bundle created by the dynamic product bundler system 316 can include any combination of a plurality of empty variables and/or static elements. The empty variables and the static elements can be part of a product array that is created by the dynamic product bundler system 316. The product array can be part of the dynamic product bundle. The static elements can be created by the dynamic product bundler system 316, while it is creating the dynamic product bundle to include product URLs that reference primary products. Product URLs that references primary products can be injected into the empty variable of the dynamic product bundle after the dynamic product bundle is created. The dynamic product bundle is dynamic in that a plurality of product URLs that references a primary product can be injected into the empty variable after the dynamic product bundle is created and before runtime. Therefore, the dynamic product bundle changes from not including the primary product referenced by the injected product URL, after the dynamic product bundle is created, to including the primary product referenced by the injected product URL before runtime.

In creating the dynamic product bundle by creating static elements that include product URLs that reference primary products, the dynamic product bundler system 316 can create conditions associated with the primary product referenced by the product URLs that are included in the static elements. The conditions can be requirements that must be met before an interface, through which a user can download a certain primary product included in the bundle, is displayed on the requestor device 318-1 . . . 318-n. The conditions can be based on any of the data that is contained in the advertised product datastore 302, the primary product datastore 304, the interface datastore 306, the receipt datastore 310 or the digital signature datastore 308. For example, the conditions can be based on the system requirements that are necessary to run the product. In another example, the conditions can also be based on other characteristics of the product such as the version of the product.

The dynamic product bundle created by the dynamic product bundler system 316 that includes empty variables can be stored on the dynamic primary product bundles datastore 314. The product binder system 322 can receive the dynamic product bundle from the dynamic product bundler system 316 or the dynamic primary product bundles datastore 314. The product binder system 322 can function to inject product URLs that reference primary products into the empty variables of the dynamic primary product bundle after the dynamic primary product bundle is created. In injecting product URLs elements within the product array can be created that represent primary products. The elements can be static in that they do not change after being created. The product binder system 322 can use the data that describes the characteristic of a primary product, the producer of a primary product or the publisher of the primary product that is associated with the dynamic primary product to retrieve data about a primary product from the primary product datastore 304. The product binder system 322 can also use a request for a primary product received from a requestor device to retrieve data about a primary product from the primary product datastore 304. The data about a primary product retrieved from the primary product datastore 304 can include the product URLs of the primary products that can be injected into the empty variables of the product array of the dynamic primary product bundle.

In injecting product URLs into the empty variables of the dynamic product bundle, the product binder system 322 can also create conditions associated with the primary product referenced by the injected product URLs. The conditions can be requirements that must be met before an interface, through which a user can download a certain primary product included in the bundle, is displayed on the requestor device 318-1 . . . 318-n. The conditions can be based on any of the data that is contained in the advertised product datastore 302, the primary product datastore 304, the interface datastore 306, the receipt datastore 310 or the digital signature datastore 308. For example, the conditions can be based on the system requirements that are necessary to run the product. In another example, the conditions can also be based on other characteristics of the product such as the version of the product. The dynamic product bundle, after the product binder system 322 has injected one or any number of product URLs into the empty variables can be stored on the runtime dynamic primary product bundles datastore 320. The requestor device 318-1 . . . 318-n can receive the dynamic product bundle from the product binder system 322 or the runtime dynamic primary product bundles datastore 320.

The dynamic product bundle is not only dynamic after the primary product bundle is created but also during runtime. The dynamic product bundle is dynamic during runtime in that the pointer that is used to interact with the product bundle as part of running the product bundle on the requestor device 318-1 . . . 318-n is adjustable. The pointer is adjustable in that it points to an element, representing a primary product, in the product array based upon the conditions. Specifically, in running the product bundle on the requestor device 318-1 . . . 318-n the requestor device characteristics are determined. Such characteristics can be the operating system that the device utilizes, what other products are installed or are available on the requestor device or the computational resources that are available on the requestor device 318-1 . . . 318-n. The requestor device characteristics can be used to determine whether or not the conditions are met. Based upon whether or not the conditions are met the pointer can alternate between different elements contained in the array. As the pointer alternates, different products, including primary products, represented by different elements, can be displayed during runtime out of the sequential order that corresponds to the placement of the elements within the product array. As to whether or not conditions are met can depend on the requestor device, a user on one requestor device who is running the dynamic product bundle may see different products from another user on another request device who is running the same dynamic product bundle. Therefore, the dynamic product bundle can display different products, including primary products, dynamically at runtime.

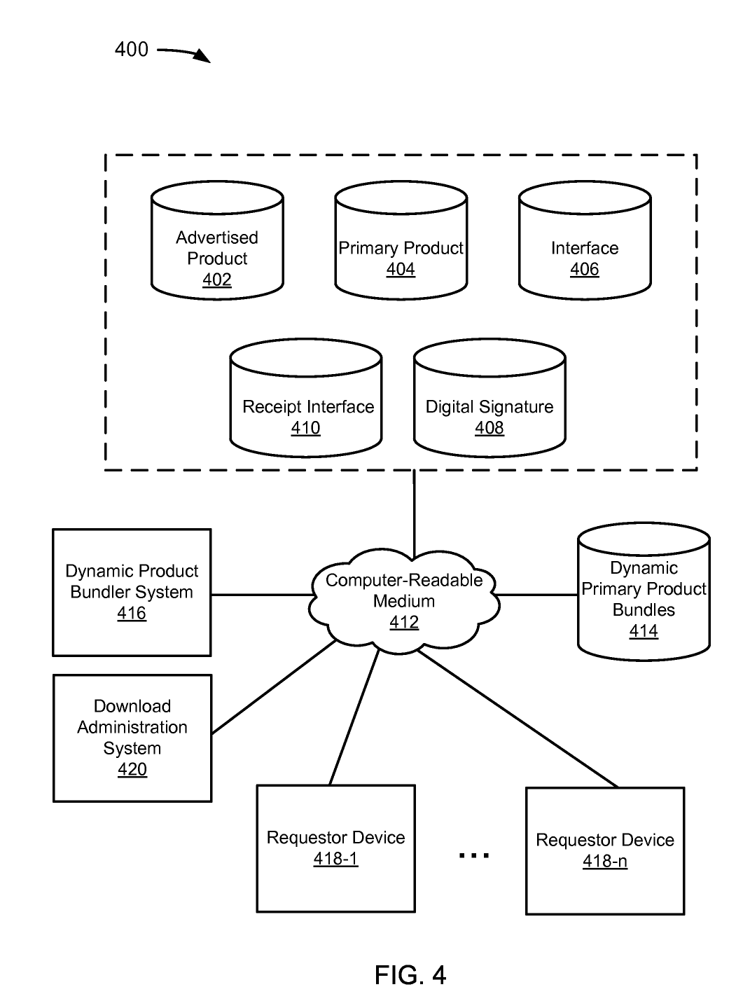

FIG. 4 depicts a diagram 400 of an example of a system configured to create a dynamic product bundle and monitor the downloading of the products within the bundle. The system shown in FIG. 4 includes an advertised product datastore 402, a primary product datastore 404, an interface datastore 406, a digital signature datastore 408 and a receipt interface datastore 410.

The primary product datastore 404 can contain data about primary products. The data about primary products can include any of the data or information that is contained within the primary product datastores of the example systems in FIGS. 1-3. The advertised product datastore 402 can contain data about advertised products. The data about advertised products can include any of the data or information that is contained within the advertised product datastores of the example systems in FIGS. 1-3. The interface datastore 406 can contain data about interfaces. The data about interfaces can include any of the data or information that is contained within the interface datastores of the example systems in FIGS. 1-3. The digital signature datastore 408 can contain data about digital signatures. The data about digital signatures can include any of the data or information that is contained within the digital signature datastores of the example systems in FIGS. 1-3. The receipt interface datastore 410 can contain data about receipt interfaces. The data about receipt interfaces can include any of the data or information that is contained within the receipt interface datastores of the example systems in FIGS. 1-3.

The advertised product datastore 402, the primary product datastore 404, the interface datastore 406, the digital signature datastore 408 and the receipt interface datastore 410 are coupled to a dynamic product bundler system 416, a dynamic primary product bundles datastore 414, requestor devices 418-1 . . . 418-n and a download administration system 420, through a computer-readable medium 412.

The dynamic product bundler system 416 can be implemented as and perform the same functions as the dynamic product bundler system 116 of the example system in FIG. 1. The dynamic primary product bundles datastore 414 can contain the same data as the dynamic primary product bundles datastore 114 of the example system in FIG. 1. The requestor devices 418-1 . . . 418-n can be implemented as and perform the same functions as any of the requestor devices of the example systems in FIGS. 1-3.

The download administration system 420 can function to monitor the activities of the user of the requestor devices 418-1 . . . 418-n during all aspects of the product bundling process. Specifically, the product bundling process can begin when a user requests a primary product through the requestor devices 418-1 . . . 418-n. The product bundling process can continue until all products within the product bundle have been presented to the user and the user has made a decision whether to install all of the products within the bundle. In monitoring the activity of the user, the download administration system 420 can collect and/or generate product bundling data related to all aspects of the product bundling process. The product bundling data can be stored in a product bundling information datastore that can be integrated as part of the download administration system.

The product bundling data can be used by the download administration system 420 to control how the dynamic product bundler system 416 or any other system described in this paper creates bundles. Specifically, the dynamic administration system 420 can create conditions or rules that the dynamic product bundler system 416 or any other system described in this paper follow in creating product bundles. The conditions or rules can be based on the operating system of the user, default browser of the user, the version and default settings of the browser of the user, the registry key/value of the requestor devices 418-1 . . . 418-n, the local files on the requestor device 418-1 . . . 418-n, custom defined parameters, as will be discussed in greater detail later, the geographical region of the user or the request device 418-1 . . . 418-n, a frequency cap, as will be discussed in greater detail later or any kind of variant, as will be discussed in greater detail later.

Specifically, the download administration system 420 can use the product bundling data to manage distribution of a product. Specifically, product creators or distributors can define limits on the distribution of the product, including frequency caps. For example, a product creator can create a limit that only 200,000 copies of the product be distributed. Using the product bundling data, such as the number of times that the product is accepted, the download administration system 420 can help to ensure that the product is not distributed beyond the limits set by the product creators or distributors. For example, if the number of distributed copies of a product has reached the distribution limit, the download administration system 420, can instruct the dynamic product bundler system 416 or any other system in the FIGS. of this paper to stop including the product within product bundles.

The product bundling data can be classified into user activity data, user environment data and custom-defined data. The user activity data can include data about the actions performed by the user during the bundling process. For example, the user activity data can include whether a user has accepted or declined a product and more specifically whether a user has accepted or declined to install a product in the product bundle on the requestor device 418-1 . . . 418-n. The user activity data can also include which advertised products or primary products a user has expressed an interest in, as can be determined, for example, by the amount of time between when the user is presented with the product and the user declines the product. Additionally the user activity data can include whether a user selects a products subtending feature, or whether a user exits or abandons the requestor device 418-1 . . . 418-n or the product bundle during the bundling process.

The user environment data can include data about the environment in which the user interacts with the product bundle. The user environment data can include information about the user's application, operating system and web browser environment. For example, the user environment data can include information about what web browser the user is using while interacting with the product bundle. In another example, the user environment data can include the configuration of the web browser that the user is using while interacting with the product bundle. Additionally, the user environment data can include geographical information about the user. For example, the user environment data can include what the geographical location of the user when they are interacting with the product bundle.

The custom-defined data can be specific types of data that an entity defines. The entity can be the provider of the products that form, in part, a product bundle, or the generate of the product bundle. The custom-define data can be defined according to predefined parameters that can be used to categorize a user. The predefined parameters can include the domain of distribution of a product, affiliated products, the source of the product and advertising or marketing campaigns for the product. In being used to categorize a user, the predefined parameters can be used to segment user traffic, identify different groups of users and their corresponding activities for bundling organization and efficiency purposes.

In collecting and/or generating custom-defined data, the download administration system can be implemented in a three tiered cascading manner. This allows for the changing of the predefined parameters in the event that the values of the predefined parameters have changed or deprecated. Specifically, the predefined parameters can be defined before the bundle is created and overridden while the bundle is being created. Alternatively, the predefined parameters can be defined during the create of a generic bundle and overridden when a modified bundle based on the generic bundle is created.

The download administration system 420 can also generate reports based on the product bundling data. The generation of reports can be included as part of the monitoring, by the download administration system 420, of the activities of the user of the requestor devices 418-1 . . . 418-n during all aspects of the product bundling process. The reports can be filtered based on the predefined parameters used in creating the custom-defined data or the user regions for which the report is generated. The report can be configured to display to the entity that creates the product bundles or the entity that creates products, including the products in the product bundle.

In generating reports, the download administration system 420 can create a bundle report. The bundle report can include information detailing bundle-specific performance metrics for any number of bundles. Specifically, the bundle reports can include information describing the performance of individual products within the any number of bundles. The information describing the performance of individual products can include the number of times the product was accepted or declined and the amount of revenue generated for the product. The bundle reports can also include the information on the amount of revenue generated for the bundles of which the report is about.

The download administration system 420 can also create product reports. The product reports can be for a specific product that is included within the bundle. The product report can include product-specific performance metrics of a product included in a product bundle. Specifically, the product report can include information about the number of times a product was accepted or declined. Additionally, the product report can include information about the amount of revenue generated by the product. The product-specific performance metrics can be for a specific product across all of the bundles in which the specific product is included.

The download administration system 420 can also create partner reports. The partner reports can contain all information contained either within the product reports or the bundle reports for any number of specific products of which the partner is associated. In one example, a partner is associated with a product if they produced the product. In another example, a partner is associated with a product if they provide the product to the market. A partner identification can be used to signify what products or bundles of which the partner is associated. Specifically, a product can be labeled with the partner identification and the download administration system 420 can generate a partner report for all of the products that are labeled with the partner identification.

The download administration system 420 can also function in part to create a multivariate testing system. Specifically, in collecting and/or generating product bundling data and generating reports, the download administration system 420 allows for automated segmentation of traffic and the tracking of separate variants in product bundles. The variants can be based on and associated with the specific products that are included in the product bundles or the specific product bundles themselves. For example, the variant can be what other products are included in a bundle with a specific product. Variants can be associated with variant identifiers that can be used to generate reports based on the variants. The reports can allow for performance testing of the products and the bundles or portions of bundles that include the products. The reports that are generated for the variants, as with the previously described reports, can be filtered based on the variant, so that a report can be for a specific variant or any number of specific variants.

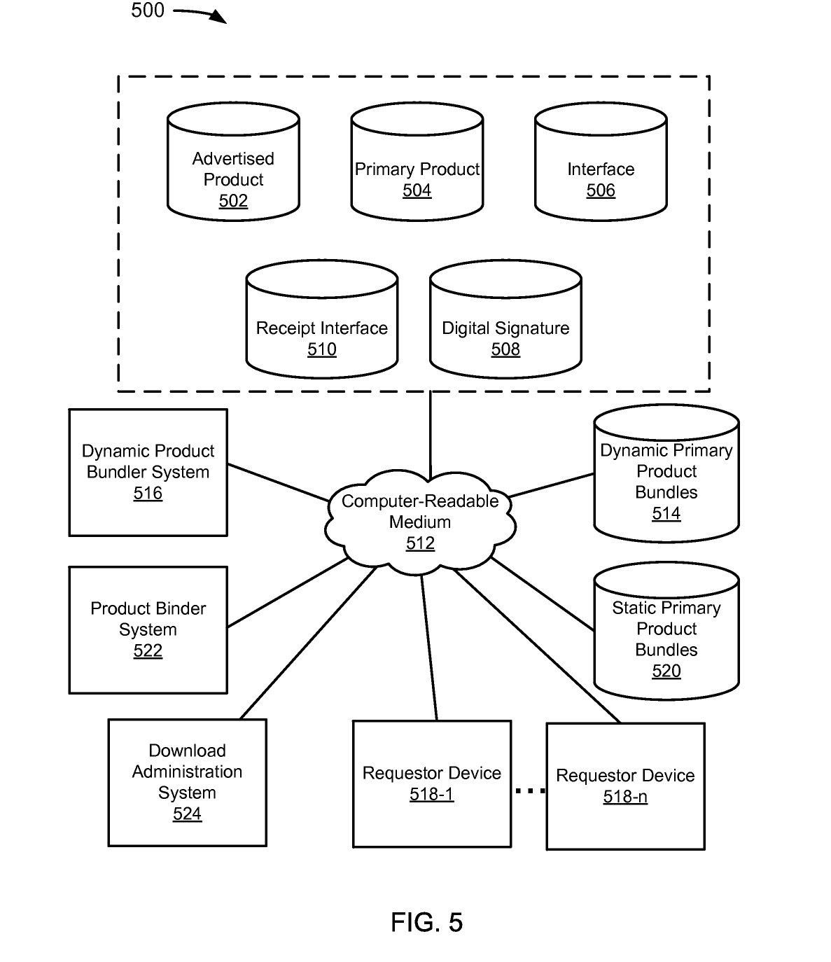

FIG. 5 depicts a diagram 500 of an example of another system configured to create a dynamic product bundle and monitor the downloading of the products within the bundle. The system shown in FIG. 5 includes an advertised product datastore 502, a primary product datastore 504, an interface datastore 506, a digital signature datastore 508 and a receipt interface datastore 510.

The primary product datastore 504 can contain data about primary products. The data about primary products can include any of the data or information that is contained within the primary product datastores of the example systems in FIGS. 1-3. The advertised product datastore 502 can contain data about advertised products. The data about advertised products can include any of the data or information that is contained within the advertised product datastores of the example systems in FIGS. 1-3. The interface datastore 506 can contain data about interfaces. The data about interfaces can include any of the data or information that is contained within the interface datastores of the example systems in FIGS. 1-3. The digital signature datastore 508 can contain data about digital signatures. The data about digital signatures can include any of the data or information that is contained within the digital signature datastores of the example systems in FIGS. 1-3. The receipt interface datastore 510 can contain data about receipt interfaces. The data about receipt interfaces can include any of the data or information that is contained within the receipt interface datastores of the example systems in FIGS. 1-3.

The advertised product datastore 502, the primary product datastore 504, the interface datastore 506, the digital signature datastore 508 and the receipt interface datastore 510 are coupled to a dynamic product bundler system 516, a dynamic primary product bundles datastore 514, requestor devices 518-1 . . . 518-n, a product binder system 522, a static primary product bundles datastore 520 and a download administration system 524, through a computer-readable medium 512.

The dynamic product bundler system 516 can be implemented as and perform the same functions as the dynamic product bundler system 216 of the example system in FIG. 2. The dynamic primary product bundles datastore 514 can contain the same data as the dynamic primary product bundles datastore 214 of the example system in FIG. 2. The product binder system 522 can be implemented as and perform the same functions as the product binder system 222 of the example system in FIG. 2. The static primary products bundles datastore 520 can contain the same data as the static primary products bundles datastore 220 of the example system in FIG. 2. The requestor devices 518-1 . . . 518-n can be implemented as and perform the same functions as any of the requestor devices of the example systems in FIGS. 1-3. The download administration system 524 can be implemented as and perform the same functions as the download administration system 420 of the example system in FIG. 4.

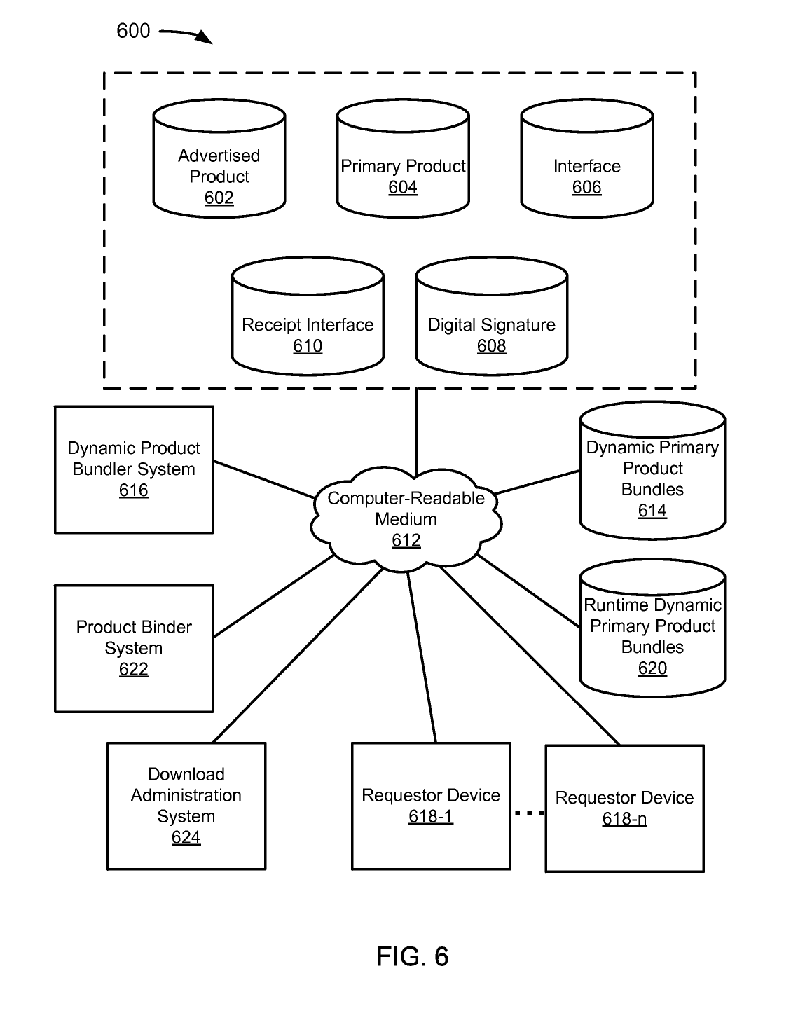

FIG. 6 depicts a diagram 600 of an example of another system configured to create a dynamic product bundle and monitor the downloading of the products within the bundle. The system shown in FIG. 6 includes an advertised product datastore 602, a primary product datastore 604, an interface datastore 606, a digital signature datastore 608 and a receipt interface datastore 610.

The primary product datastore 604 can contain data about primary products. The data about primary products can include any of the data or information that is contained within the primary product datastores of the example systems in FIGS. 1-3. The advertised product datastore 602 can contain data about advertised products. The data about advertised products can include any of the data or information that is contained within the advertised product datastores of the example systems in FIGS. 1-3. The interface datastore 606 can contain data about interfaces. The data about interfaces can include any of the data or information that is contained within the interface datastores of the example systems in FIGS. 1-3. The digital signature datastore 608 can contain data about digital signatures. The data about digital signatures can include any of the data or information that is contained within the digital signature datastores of the example systems in FIGS. 1-3. The receipt interface datastore 610 can contain data about receipt interfaces. The data about receipt interfaces can include any of the data or information that is contained within the receipt interface datastores of the example systems in FIGS. 1-3.

The advertised product datastore 602, the primary product datastore 604, the interface datastore 606, the digital signature datastore 608 and the receipt interface datastore 610 are coupled to a dynamic product bundler system 616, a runtime dynamic primary product bundles datastore 614, requestor devices 618-1 . . . 618-n, a product binder system 622, a runtime primary product bundles datastore 620 and a download administration system 624, through a computer-readable medium 612.

The dynamic product bundler system 616 can be implemented as and perform the same functions as the dynamic product bundler system 316 of the example system in FIG. 3. The dynamic primary product bundles datastore 614 can contain the same data as the dynamic primary product bundles datastore 314 of the example system in FIG. 3. The product binder system 622 can be implemented as and perform the same functions as the product binder system 322 of the example system in FIG. 3. The runtime dynamic primary products bundles datastore 620 can contain the same data as the runtime dynamic primary products bundles datastore 320 of the example system in FIG. 3. The requestor devices 618-1 . . . 618-n can be implemented as and perform the same functions as any of the requestor devices of the example systems in FIGS. 1-3. The download administration system 624 can be implemented as and perform the same functions as the download administration system 420 of the example system in FIG. 4.

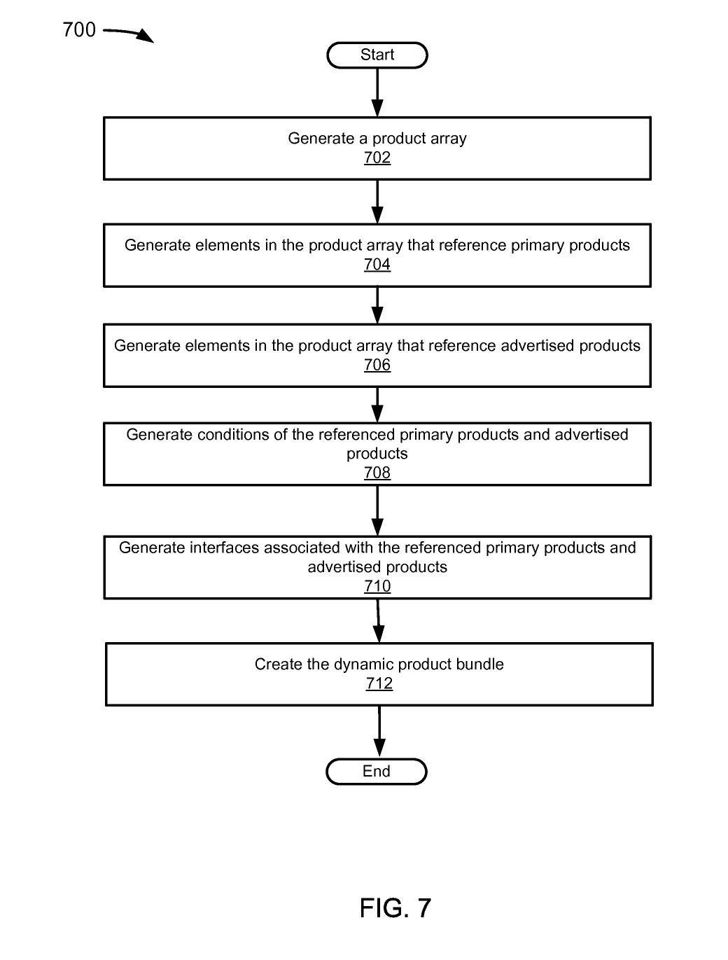

FIG. 7 depicts a flowchart 700 of an example of a method for creating a dynamic product bundle. The flowchart begins, at module 702, with generating a product array. The product array can be used to form part of dynamic product bundle. Next, at module 704, the flowchart includes generating elements in the product array that reference primary products. The elements can be static in that they do not change during runtime. Next, at module 706, the flowchart includes generating elements in the product array that reference advertised products. The elements generated at module 706 can also be static in that they do not change during runtime. Next, at module 708, the flowchart includes generating conditions of the referenced primary products and advertised products. The conditions can be formed as parts of the dynamic product bundle. Next, at module 710, the flowchart includes generating interfaces associated with referenced primary products and advertised products. Next, at module 712, the flowchart includes creating the dynamic product bundle.

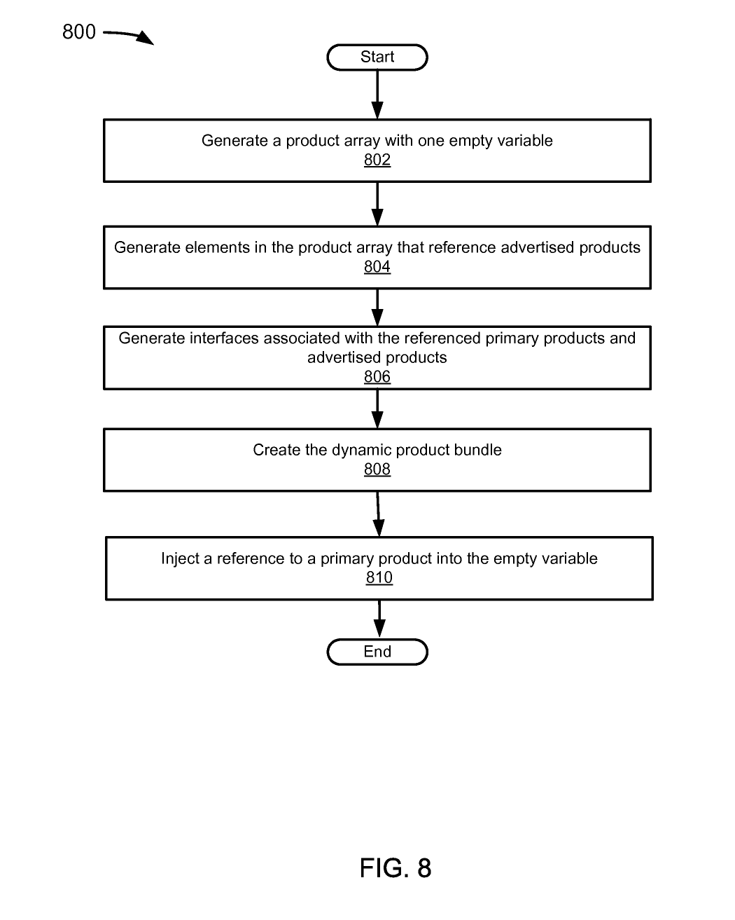

FIG. 8 depicts a flowchart 800 of an example of a method for creating and operating a dynamic product bundle. The flowchart begins, at module 802, with generating a product array with one empty variable. The product array can be used to form part of dynamic product bundle. Next, at module 804, the flowchart includes generating elements in the product array that reference advertised products. The elements can be static in that they do not change during runtime. Next, at module 806, the flowchart includes generating interfaces associated with the referenced primary products and advertised products. Next, at module 808, the flowchart includes creating the dynamic product bundle. Next, at module 810, the flowchart includes injecting a reference to a primary product into the empty variable.

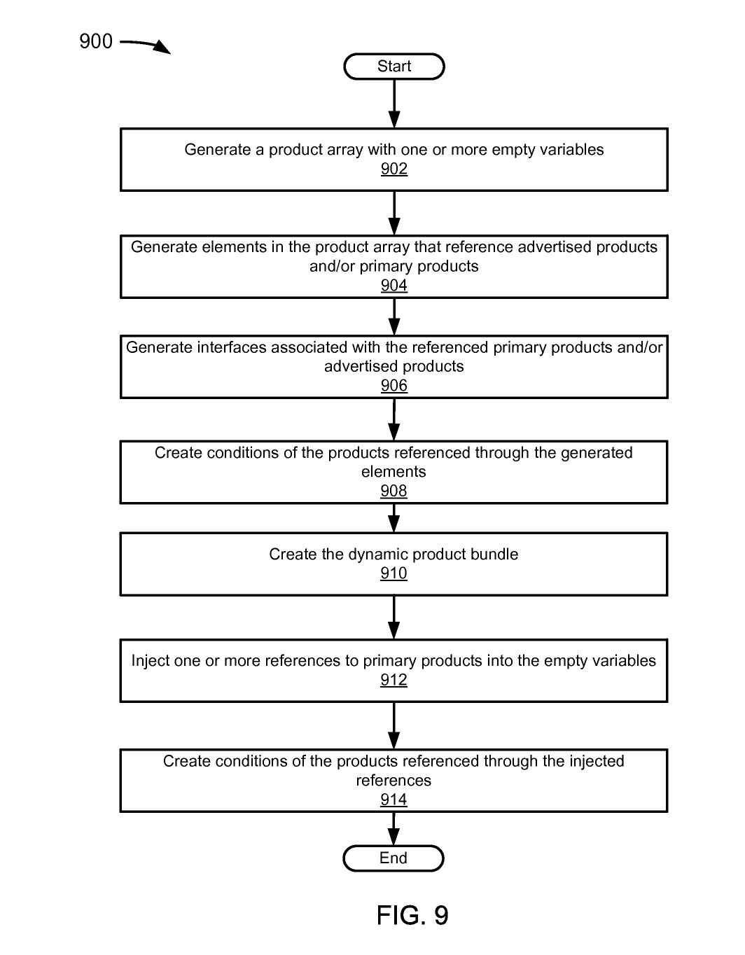

FIG. 9 depicts a flowchart 900 of an another example of a method for creating and operating a dynamic product bundle that is dynamic at runtime. The flowchart begins, at module 902, with generating a product array with one or more empty variables. The product array can be used to form part of dynamic product bundle. Next, at module 904, the flowchart includes generating elements in the product array that reference advertised products and/or primary products. The elements can be static in that they do not change during runtime. Next, at module 906, the flowchart includes generating interfaces associated with the referenced primary products and/or advertised products. Next, at module 908, the flowchart includes creating conditions of the products referenced through the generated elements. The conditions can be formed as parts of the dynamic product bundle. Next, at module 910, the flowchart includes creating the dynamic product bundle. Next, at module 912, the flowchart includes injecting one or more references to the primary products into the empty variables. Next, at module 914, the flowchart includes creating conditions of the products referenced through the generated elements. The conditions generated at module 914 can further be added to the already created dynamic product bundle.

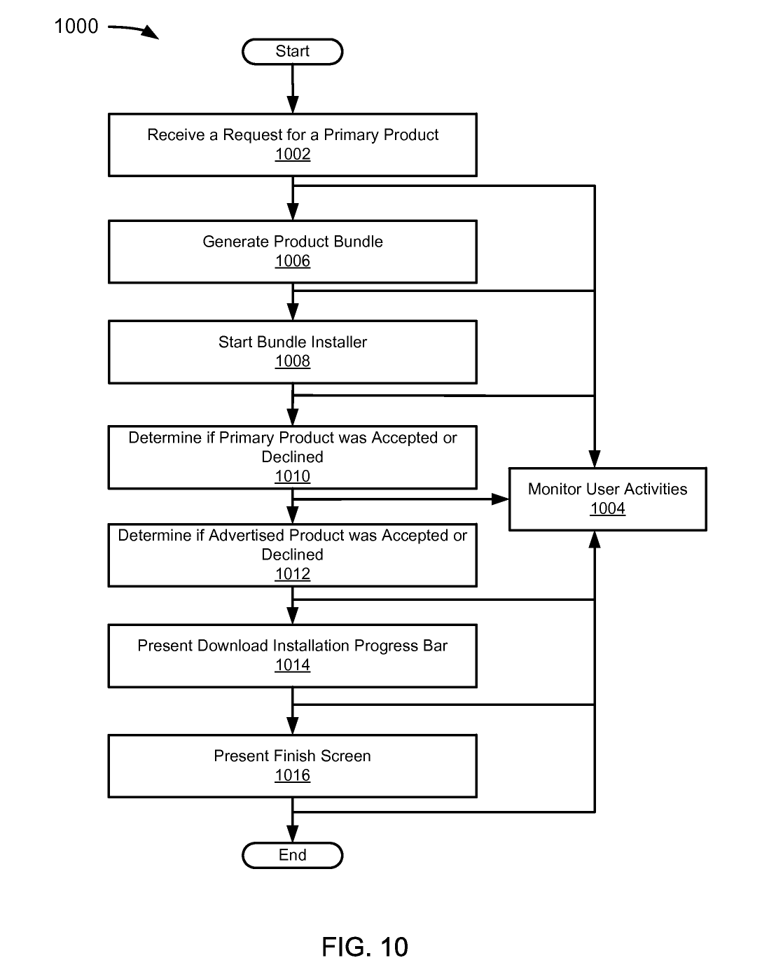

FIG. 10 depicts a flowchart 1000 of an example of a method for creating a product bundle, installing products in a product bundle and monitoring user activities. The flowchart includes, at module 1002, receiving a request to install a primary product from a user. The flowchart includes, at module 1004, with monitoring the user activities of the user who requested the primary product at module 1002. Monitoring the user activities can include any of the monitoring of the user activities performed by any of the download administration systems described in this paper. The flowchart includes, at module 1006, generating a product bundle. The product bundle can be generated based on the request for a primary product received at module 1002. The product bundle can also be generated based on product bundling data generated and/or collected as part of monitoring user activities at module 1004.

After or during generation of the product bundle 1006, the flowchart includes at module 1004, monitoring the user activities. Additionally, the flowchart includes, at module 1008, with the starting of the bundle install. This can include sending the product bundle to the users device and running the installation of the product bundle. After or during the start of the bundle install at module 1008, the method can continue to module 1004, wherein the user activities are monitored. Additionally, the flowchart includes, at module 1010, determining whether the primary product was accepted or declined by the user. After it is determined whether the primary product is accepted or declined, the flowchart includes, at module 1004, monitoring the user activities. Additionally, the flowchart includes, at module 1012, determining whether the advertised product or products were accepted or declined. After it is determined whether the advertised products are accepted, the method can continue to module 1004, wherein the user activities are monitored. The flowchart includes, at module 1014, presenting the user with the download installation progress bar 1014. During or after presenting the user with the download installation progress bar at module 1014, the flowchart includes, at module 1004, monitoring the user activities. Additionally, the flowchart includes, at module 1016, presenting the download installation finish screen to the user. After or during the presentation of the download finish screen to the user at module 1016, the flowchart includes at module 1004, monitoring activities of the user.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
receiving, by a dynamic product bundler system, a request to download a requested primary product from a requestor device;
creating a first static element in a product array that represents the requested primary product;
retrieving other primary product data, the other primary product data representing another primary product, the another primary product associated with the requested primary product;
creating a second static element in the product array that represents the another primary product;
creating conditions for the another primary product, the conditions being based on the another primary product data and required to be met before the another primary product is presented on the requestor device;
creating a dynamic primary product bundle from the product array and the conditions for the another primary product, the dynamic primary product bundle including the first static element in the product array that represents the primary product, the second static element in the product array that represents the another primary product and the conditions for the another primary product;
sending the dynamic primary product bundle to the requestor device.

2. The method of claim 1, further comprising:
retrieving advertised product data, the advertised product data representing an advertised product that is associated with either one or both the requested primary product and the another primary product;
creating an advertised product element in the product array, the advertised product element representing the advertised product;
including the advertised product element in the dynamic primary product bundle

3. The method of claim 1, further comprising:
retrieving interface data associated with one or both the requested primary product and the another primary product, the interface data including the interfaces to display on the requestor device when presenting one or both the requested primary product and the another primary product;
including the interface data in the dynamic primary product bundle.

4. The method of claim 1, further comprising:
retrieving receipt interface data associated with one or both the requested primary product and the another primary product, the receipt interface data including the interfaces to display on the requestor device when presenting after a user has downloaded one or both the requested primary product and the another primary product;
including the receipt interface data in the dynamic primary product bundle.

5. The method of claim 1, further comprising:
retrieving data about digital signatures associated with one or both the request primary product and another primary product;
including the digital signatures in the dynamic primary product bundle.

6. The method of claim 2, further comprising:
creating advertised product conditions for the advertised product, the advertised product conditions being based on the advertised product data and required to be met before the advertised product is presented on the requestor device;
including the advertised product conditions in the dynamic product bundle.

7. The method of claim 1, further comprising, monitoring activities of a user of the requestor device during the product bundling process and collecting or generating product bundling data.

8. The method of claim 7, further comprising, controlling the dynamic product bundle based on the product bundling data.

9. The method of claim 8, wherein, controlling the dynamic product bundle based on the product bundling data includes removing the another primary product from the dynamic product bundle if a frequency cap for the another primary product is exceeded, whether the frequency cap is exceeded being determined from the product bundling data.

10. The method of claim 7, further comprising, generating a report based on the product bundling data.

11. A system comprising:
a primary product datastore, the primary product datastore including requested primary product data representing a requested primary product and another primary product data representing another primary product, the another primary product associated with the requested primary product;
a dynamic product bundler system configured to receive a request for the requested primary product from a requestor device, retrieve the requested primary product data and the another primary product data from the primary product datastore, create a dynamic product bundle and generate conditions for the another primary product, the conditions being based on the another primary product data and required to be met before the another primary product is presented on a requestor device, the dynamic product bundle including the conditions and a product array that includes a first static element that represents the requested primary product and a second static element that represents the another primary product.

12. The system of claim 11, further comprising:
an advertised product datastore that includes advertised product data representing an advertised product that is associated with either one or both the requested primary product and the another primary product;
the dynamic product bundler system further configured to retrieve the advertised product data and create an advertised product element representing the advertised product in the product array based on the advertised product data, the advertised product element being included in the dynamic product bundle.

13. The system of claim 11, further comprising:
an interface datastore that includes interface data associated with one or both the requested primary product and the another primary product, the interface data including the interface to display on the requestor device when presenting one or both the requested primary product and the another primary product;
the dynamic product bundler system further configured to retrieve the interface data from the interface datastore and include the interface data in the dynamic primary product bundle.

14. The system of claim 11, further comprising:
a receipt interface datastore that include receipt interface data associated with one or both the requested primary product and the another primary product, the receipt interface data including the interfaces to display on the requestor device when presenting after a user has downloaded one or both the requested primary product and the another primary product;
the dynamic product bundler system further configured to retrieve the receipt interface data from the receipt interface datastore and include the receipt interface data in the dynamic primary product bundle.

15. The system of claim 11, further comprising:
a digital signature datastore that includes digital signature associated with one or both the request primary product and the another primary product;
the dynamic product bundler system further configured to retrieve the digital signatures from the digital signature datastore and include the digital signatures in the dynamic primary product bundle.

16. The system of claim 12, wherein the dynamic product bundler system is further configured to create advertised product conditions for the advertised product and include the advertised product conditions in the dynamic primary product bundle, the advertised product conditions being based on the advertised product data and required to be met before the advertised product is presented on the requestor device.

17. The system of claim 11, further comprising a download administration system configured to monitor activities of a user of the requestor device during the product bundling process and collecting or generating product bundling data.

18. The system of claim 17, wherein the download administration system is further configured to control the dynamic product bundle based on the product bundling data.

19. The system of claim 18, wherein the download administration system is further configured to:
determine if a frequency cap for the another primary product is exceeded based on product bundling data;
control the dynamic product bundle based on the product bundling data by removing the another primary product from the dynamic product bundle if the frequency cap for the another primary product is exceeded.

20. The system of claim 17, wherein the download administration system is further configured to generate a report based on the product bundling data.

21. A system comprising:
means for receiving a request to download a requested primary product from a requestor device;
means for creating a first static element in a product array that represents the requested primary product;
means for retrieving other primary product data, the other primary product data representing another primary product, the another primary product associated with the requested primary product;
means for creating a second static element in the product array that represents the another primary product;
means for creating conditions for the another primary product, the conditions being based on the another primary product data and required to be met before the another primary product is presented on the requestor device;
means for creating a dynamic primary product bundle from the product array and the conditions for the another primary product, the dynamic primary product bundle including the first static element in the product array that represents the primary product, the second static element in the product array that represents the another primary product and the conditions for the another primary product;
means for sending the dynamic primary product bundle to the requestor device.
